(19) United States
(12) Patent Application Publication
(10) Pub. No.: US 2001/0040930 A1
(43) Pub. Date: Nov. 15, 2001

(54) MULTI-BAND DIRECT SAMPLING RECEIVER

(76) Inventor: DUANE L. ABBEY, CEDAR RAPIDS, IA (US)

Correspondence Address: ROCKWELL COLLINS INC, KYLE EPPELE, 400 COLLINS ROAD N E, CEDAR RAPIDS, IA, 52498

(21) Appl. No.: 08/994,589

(22) Filed: Dec. 19, 1997

(51) Int. Cl. H04L 27/06

(52) U.S. Cl. 375/316

(57) ABSTRACT

A multi-band direct sampling receiver is described. The multi-band direct sampling receiver of the present invention is based upon state-of-the-art, very high speed integrated circuit and digital signal processing. As such, the performance of the direct sampling receiver of the present invention contemplates improvements in large, very high-speed integrated circuits. The direct sampling receiver of the present invention contemplates large scale integration and very large scale integration techniques.

### BACKGROUND OF THE INVENTION

The present invention generally relates to the field of digital radio-frequency receivers, and more particularly to a multi-band direct sampling receiver.

Intermediate-frequency sampling receivers (IFSRs) utilize a conventional superheterodyne analog receiver to produce a low frequency IF, generally less than 5 MHz. The IF signal is digitized and then demodulated or otherwise processed digitally. The basic performance limitations of IFSRs are related to the noise, distortion, and spurious contributions of the analog receiver as well as dynamic range limitations for wider bandwidth IFs.

Direct conversion receivers (DCRS) utilize a single quadrature carrier mix, normally the injection is the same frequency as the signal carrier, to generate the 0 Hz carrier baseband modulated signal. The process ideally generates far less distortion products than IFSRs and does most of the filtering as lower frequency low-pass rather than higher frequency bandpass. The basic performance limitations are related to the linearity, gain balance, and phase balance of the quadrature channels (I & Q channels). In order to receive single sideband modulation (in particular ISB), the channel balance must be perfect or some level of distortion will result in the desired sideband due to image sideband folding into the desired sideband. In order to maintain a desired minimum of 60 dB rejection of the other sideband, the channel gain balance must be less than 0.018 dB, and the phase balance must be less than 0.11 degree, a real challenge even with the aid of gain and phase error correction post processing.

The channel balance problem becomes even worse when it must be maintained across wideband signals, for example 3 MHz bandwidth signals. If the channel mixers are not balanced and linear, AM demodulation, i.e. envelope detection, can result from any signal in the preselected bandwidth. In fact, a high level of undesired AM signal can demodulate into the baseband of the desired low level signal and render the desired reception useless. Although the level of the interference will be suppressed by the linearity of the mixers, if the interference signal is 80 to 100 dB higher than the desired signal, the balance and linearity of the mixers must be extremely good.

Direct sampling receivers combine the best aspects of both the IFSR and the DCR and adds some unique benefits of their own. No analog injections (synthesizers) or analog mixers are used, only a very high rate, fixed frequency sample clock is used. The noise, distortion, and spurious can be greatly reduced in the analog part of the receiver and can be maintained at a specific maximum level by the digital part of the receiver. The direct sampling receiver samples a very wide bandwidth of real spectrum, digitizes the samples with a very linear, high dynamic range A/D converter, and processes the rest of the reception and demodulation digitally. Once the real spectrum is digitized, it can be converted to complex baseband with arbitrarily perfect I & Q channel balance. The direct sampling receiver has the unique advantage of being able to process both narrow bandwidth and wide bandwidth signals without separate receivers.

The main performance limitations of direct sampling receivers are related to the high speed A/D converter and the high speed digital decimation processing, both of which push the boundaries of present integrated circuit technology. Although direct sampling receivers developed with today's technologies will invariably utilize more power and cost more than may be desired, and not have the full high level of performance desired, the direct sampling receivers appears to be the receiver of the future. Cost and power consumption is predicted to decrease as high speed processing circuit technology evolves, and the performance will be superior by present standards.

### SUMMARY OF THE INVENTION

Accordingly, it is a goal of this invention to provide a multi-band direct sampling receiver. The present invention described herein specifies architectures for multi-band (30 kHz to 500 MHz) receivers.

Several A/D converter requirements and architectural options of the direct sampling receiver have been put forth for both HF only receivers and HF/VHF/UHF multi-band receivers. The direct sampling receiver of the present invention is based upon state-of-the-art, very high speed integrated circuit and digital signal processing. As such, the performance of the direct sampling receiver of the present invention contemplates improvements in large, very high-speed integrated circuits. Very little is available presently off-the-shelf that can be assembled in a module and meet even the minimum performance requirements of the direct sampling receiver. However, integrated circuit technology does exist today to design and build integrated circuits that will meet at least the minimum HF direct sampling receiver requirements and probably at least the minimum multi-band direct sampling receiver requirements as well. Several integrated circuit manufacturers have and are currently developing high speed circuit processing including HMESFETs, MODFETs, CMODFETs, and HBT devices, capable of gigahertz processing rates. Developments in direct sampling receivers will be a series of modules, designed and built over time that provide increasing performance at lower cost, size and power.

It is to be understood that both the foregoing general description and the following detailed description are exemplary and explanatory only and are not restrictive of the invention as claimed.

The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous objects and advantages of the present invention may be better understood by those skilled in the art by reference to the accompanying figures in which:

FIG. 1 is an illustration of three digital radio implementations;

FIG. 2 is an illustration of a three stage low pass sigma-delta modulation analog-to-digital converter having both two and three stage outputs;

FIG. 3 is an illustration of the signal and noise spectra for the modulator of FIG. 2;

FIG. 4 is an illustration of a multiple stage low pass sigma-delta modulation analog-to-digital converter having a single bit output and feedforward/feedback stabilization;

FIG. 5 is an illustration of the signal and noise spectra for the modulator of FIG. 4, showing pass band shaping;

FIG. 6 is an illustration of a band pass sigma-delta modulation analog-to-digital converter comprising a cascade of tuned resonators and a one bit per sample output;

FIG. 7 is an illustration of the signal and noise spectra for the modulator of FIG. 6, showing passband shaping;

FIG. 8 is an illustration of RF signal conditioning apparatus preceding the analog-to-digital converter in accordance with the present invention;

FIG. 9 is an block diagram of a high frequency direct sampling receiver of the present invention;

FIG. 10 is an illustration of a decimation filter, digital down converter, interface logic and automatic gain control circuit in accordance with the present invention;

FIG. 11 is an illustration of a tailored response cascaded integrator and comb decimation filter;

FIG. 12 is an illustration of a discrete-time domain, staggered pipeline signal flow diagram, of a dual integration cascade, representative to construct high resolution digital adders, subtractors, and integrators in accordance with the present invention;

FIG. 13 is an illustration of a decimate and accumulate FIR filter in accordance with the present invention;

FIG. 14 is a block diagram of a high performance, high frequency direct sampling receiver in accordance with the present invention;

FIG. 15 is a block diagram showing additional detail of the decimation filter, digital down converter and gain control circuitry of the present invention;

FIG. 16 is a block diagram showing a tailored response cascaded integrator and comb decimation filter of the present invention;

FIG. 17 is an illustration of a decimate and accumulate FIR filter;

FIG. 18 is an illustration of cascaded integrator and comb filter;

FIG. 19 is an illustration of a programmable 128 tap symmetric coefficients FIR filter;

FIGS. 20 and 21 are an illustration of a high-performance LF/MF/HF/VHF/UHF direct sampling multi-band receiver of the present invention;

FIG. 22 is an illustration of a coarse translator and cascaded integrator and comb prefilter;

FIG. 23 is an illustration of sine and cosine injection values for ⅕ Fₛ, an example complex injection input of the present invention;

FIG. 24 is an illustration of a FIR prefilter equalizer;

FIG. 25 is an illustration of a cascaded integrator and comb decimation filter;

FIG. 26 is an illustration of a programmable 128 tap symmetric coefficients FIR filter;

FIG. 27 is an illustration of a high performance coarse translator and cascaded integrator an comb filter;

FIG. 28 is an illustration of a 6 tap FIR filter;

FIG. 29 is an illustration of a base band cascaded integrator and comb decimation filter; and

FIG. 30 is an illustration of a programmable 120 tap base band FIR equalize and decimate filter.

### DESCRIPTION OF THE PREFERRED EMBODIMENT

Reference will now be made in detail to the presently preferred embodiment of the invention, an example of which is illustrated in the accompanying drawings.

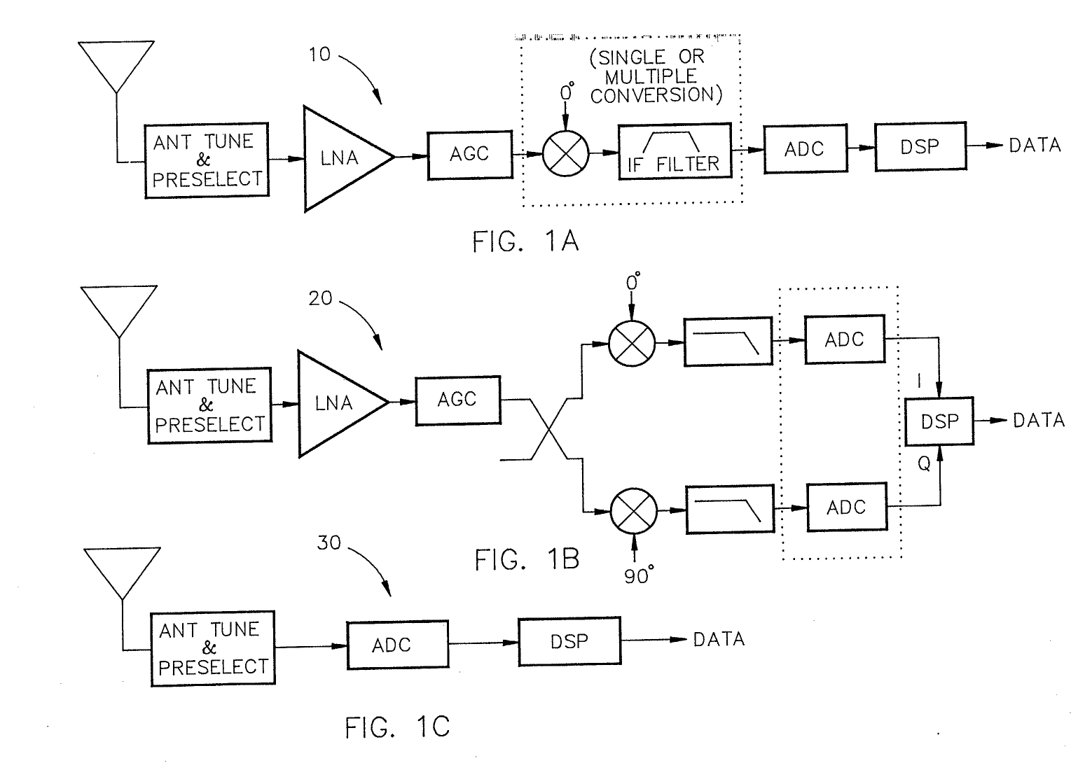

Referring now to FIGS. 1A, 1B and 1C, block diagrams of an intermediate-frequency sampling receiver, a direct conversion receiver and a direct sampling receiver are shown, respectively. An intermediate-frequency sampling receiver (IFSR) 10 as shown in FIG. 1A utilizes a conventional superheterodyne analog receiver to produce a low frequency IF being generally less than 5 MHz. The IF signal is digitized and then demodulated or otherwise processed digitally. The basic performance limitations of the IFSR are related to the noise, distortion, and spurious contributions of the analog receiver as well as dynamic range limitations for wider bandwidth intermediate-frequencies.

A direct conversion receivers (DCR) 20 as shown in FIG. 1B typically utilizes a single quadrature carrier mix wherein normally the injection is the same frequency as the signal carrier to generate the 0 Hz carrier baseband modulated signal. The process ideally generates far less distortion products than an intermediate-frequency sampling receiver and does most of the filtering as lower frequency low-pass rather than higher frequency bandpass. The basic performance limitations of the direct conversion receiver are related to the linearity, gain balance, and phase balance of the quadrature channels (I & Q channels).

In order to receive single sideband modulation (in particular ISB), the channel balance must be perfect or some level of distortion will result in the desired sideband due to image sideband folding into the desired sideband. In order to maintain the required minimum of 60 dB rejection of the other sideband, the channel gain balance must be less than 0.018 dB, and the phase balance must be less than 0.11 degree, a hard to achieve and maintain balance condition, even with the aid of balance error correction post processing.

The channel balance problem becomes even worse when it must be maintained across wideband signals, for example 3 MHz bandwidth signals. If the channel mixers are not balanced and linear, AM demodulation, i.e. envelope detection, can result from any signal in the preselected bandwidth. In fact, a high level of undesired AM signal can demodulate into the baseband of the desired low level signal and render the desired reception useless. Granted the level of the interference will be suppressed by the linearity of the mixers, but if the interference signal is 80 to 100 dB higher than the desired signal, the balance and linearity of the mixers must be extremely good.

A direct sampling receiver (DSR) 30 is shown in FIG. 1C. Direct sampling receivers combine the best aspects of both the IFSR and the DCR receivers and add some unique benefits of their own. No analog injections (synthesizers) or analog mixers are used, and only a very high rate, fixed frequency sample clock is used. The noise, distortion, and spurious can be greatly reduced in the analog part of the receiver and can be maintained at a specific maximum level by the digital part of the receiver. The direct sampling receiver samples a very wide bandwidth of real spectrum, digitizes the samples with a very linear, high dynamic range A/D converter, and processes the rest of the reception and demodulation digitally. Once the real spectrum is digitized, it can be converted to complex baseband with arbitrarily perfect I & Q channel balance. The direct sampling receiver has the unique advantage of being able to process both narrow bandwidth and wide bandwidth signals as well as potentially multiple simultaneous signal channels without separate receivers.

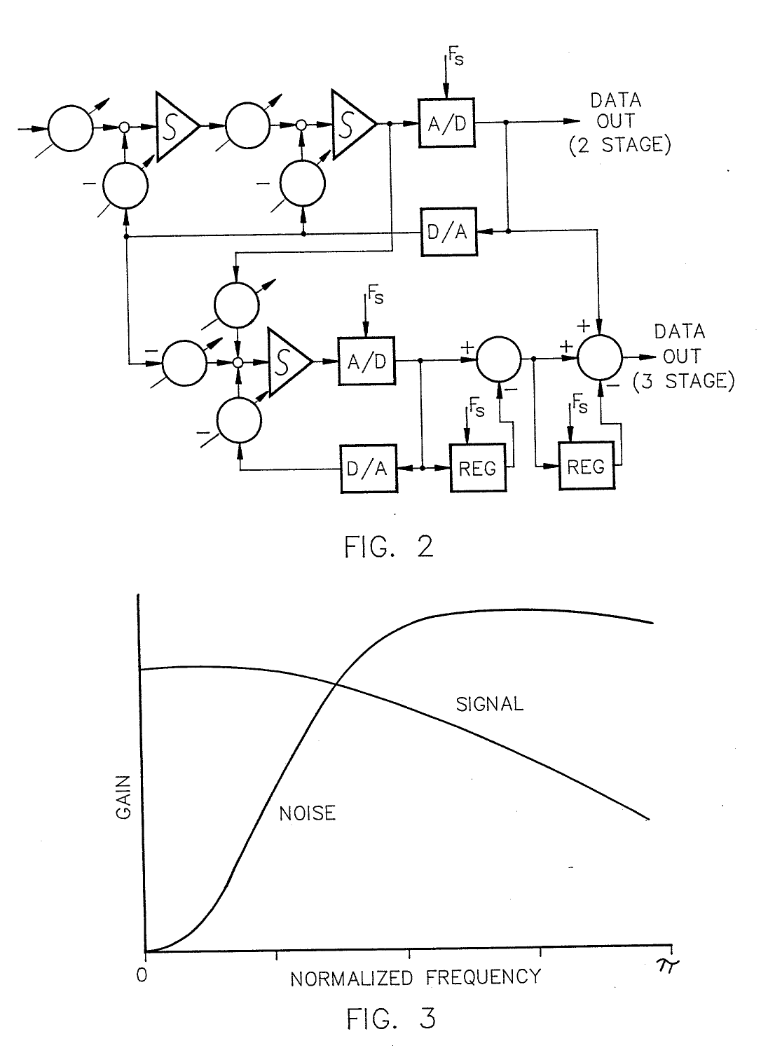

Referring now to FIG. 2, a three stage low-pass sigma-delta modulator and analog-to-digital converter having both two and three stage outputs is shown. Currently there is only one major category of A/D converters that can support the wide bandwidths and high multi-signal dynamic ranges required by the direct sampling receiver 30 of the present invention, namely a sigma-delta modulator A/D, and in particular a 1-bit A/D. The two stage output should be a 1-bit per sample output. The three stage output, as well as higher order outputs from additional stage cascades, must be multi-bit per sample outputs. Such cascaded architectures typically use 1 bit quantizers (A/D) to maintain high linearity and limit each cascaded section to 1 or 2 stages of integration for stability.

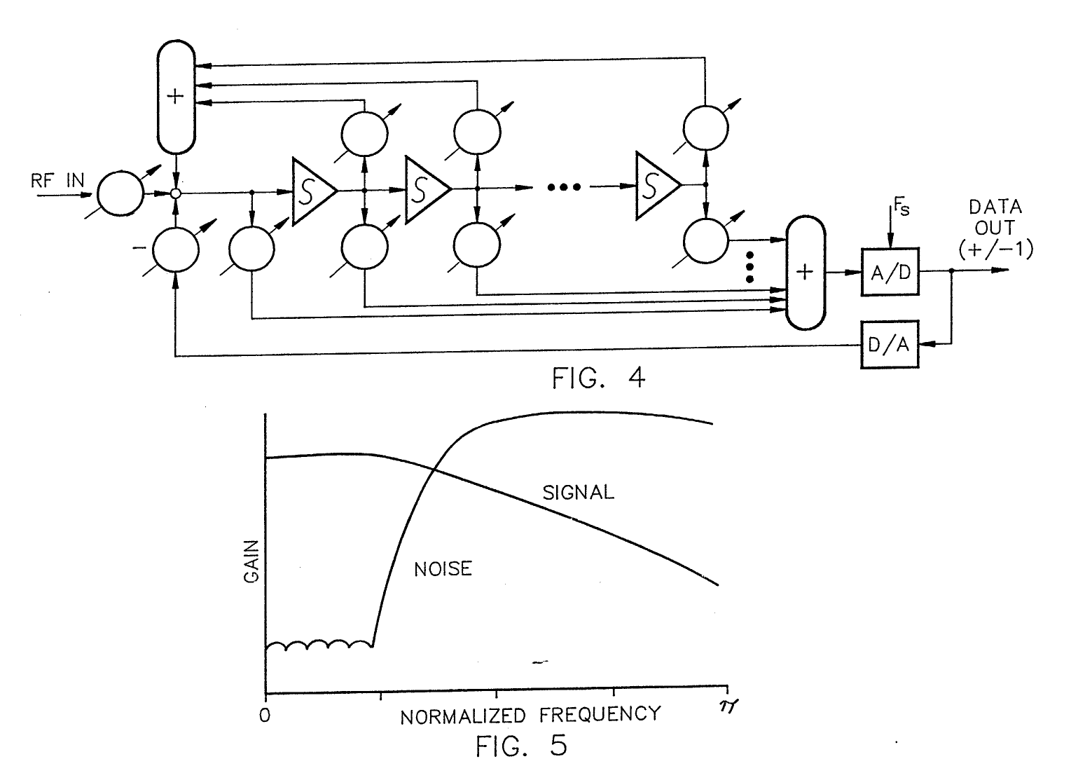

Sigma-delta modulation analog-to-digital converters overcome the noise produced by 1 bit quantizers by sampling the input signal at many times the signal bandwidth and by effectively moving the quantizer's noise from the signal bandwidth to frequencies outside of the signal bandwidth. Referring to FIG. 3, a graphical representation if the spectral noise shaping of a low pass sigma-delta modulator is shown. Ideally, each additional stage of integration produces more noise suppression in the signal bandwidth. As shown in FIG. 2, the 2 stage output shapes the noise spectrum by a factor of (1−z⁻¹)², where as the 3 stage output shapes the noise spectrum by a factor of (1−z⁻¹)³. Ideally then, each additional stage similarly cascaded would incrementally increase the noise suppression in the signal bandwidth. As a practical matter, component matching between cascaded stages is critical to maintaining the desired incremental growth in noise suppression. As such, the cascaded architecture is not likely to provide the required spurious free dynamic range and wide signal bandwidths needed for direct sampling receivers.

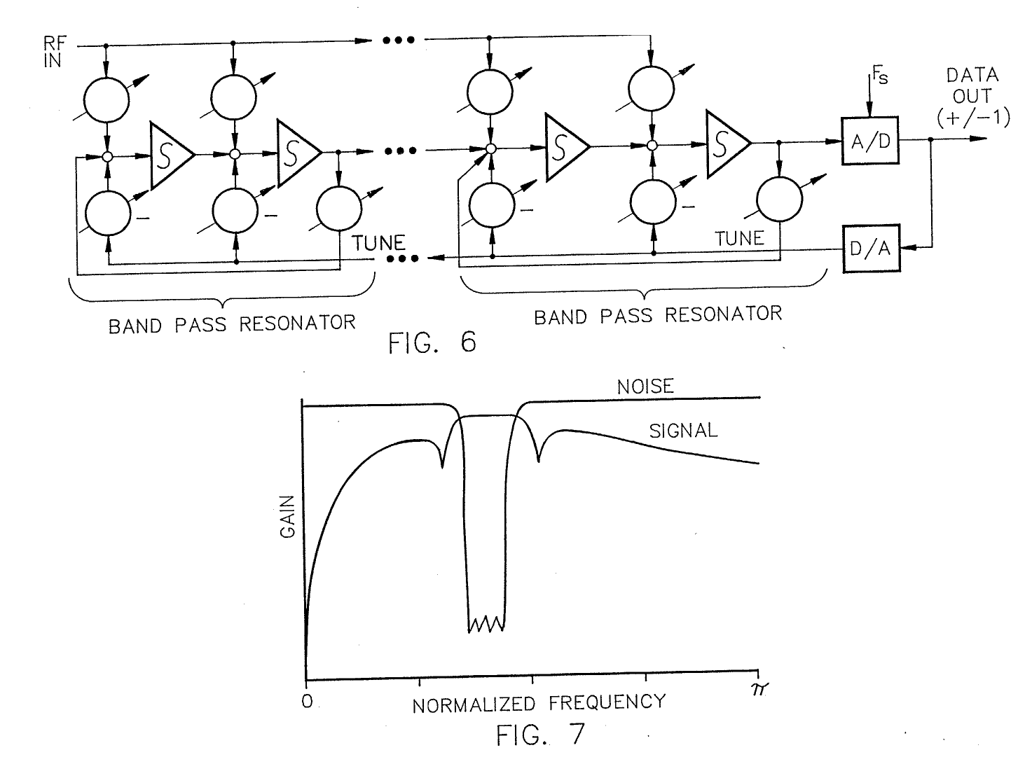

A better class of sigma-delta modulators for direct sampling receiver analog-to-digital converters is the ‘inline multi stage’ with a single 1 bit output. Referring now to FIG. 4, a multiple stage low-pass sigma-delta modulator analog-to-digital converter is shown having means for stabilizing the modulator for high level inputs, more than 2 integration stages, and maintaining a 1-bit output. The modulator employs both feed forward and feed backward signals to both shape the low-pass passband and stabilize the modulator. Individual integration stage time constants and open loop gains can be adjusted for enhanced stability. The feed forward and feedback gain adjustments shown are used to position the integration network's poles and zeros in its frequency response, so as to provide a stable modulator and optimize the pass band noise rejection. Multiple stages have the additional benefit of randomizing the pass band input to constant input signals and thereby suppressing spurious generation. Further, out of pass band signals and noise are randomized to suppress out of band spurious, which can fold in band in response to modulator stage nonlinearity and during decimation filtering. Also, just as the quantization noise is shaped and suppressed in the pass band, so is A/D addative sample clock noise suppressed in the pass band.

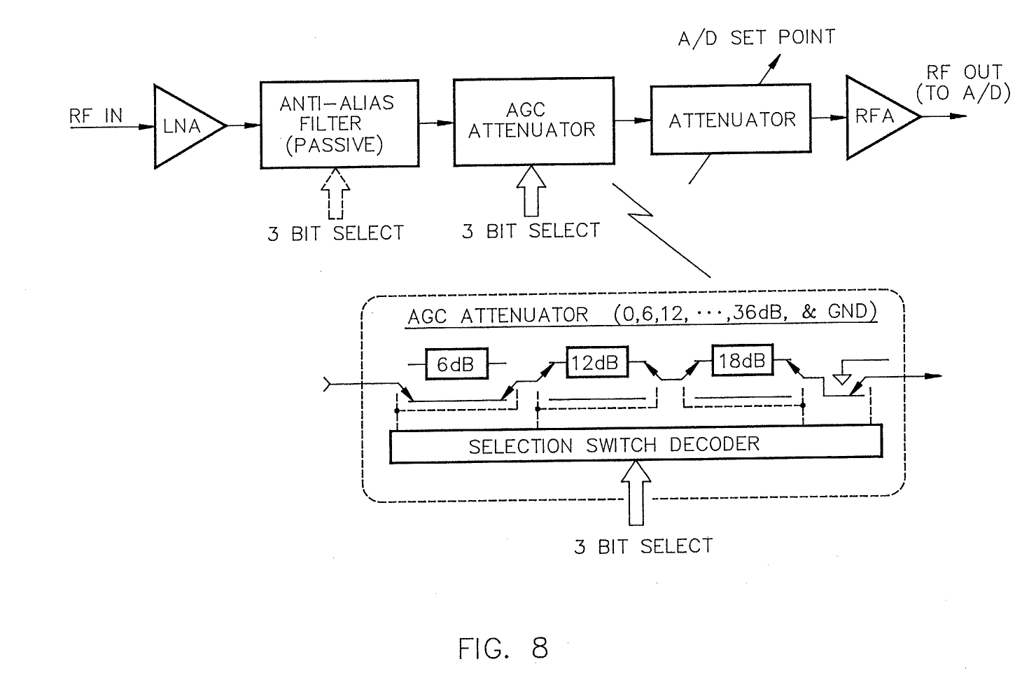

Referring now to FIG. 5, a graphical representation of the response of the multiple stage low-pass sigma-delta modulator analog-to-digital converter of FIG. 4 is shown. The noise spectrum shows an example of how the pass band response is flattened to improve performance at wider bandwidths. That is, noise suppression at higher frequencies is increased by allowing reduced noise suppression at lower frequencies. By using transistor technology that can support low pass multi stage sigma-delta modulators with sample clock rates of up to 10 gigasamples per second, direct sampling receivers covering frequency bands up through high frequency (HF=30 MHz) can be produced with >100 dB of spurious free dynamic range, and covering frequency bands up through low band ultra high frequency (UHF=400 MHz) can be produced with lesser spurious free dynamic range.

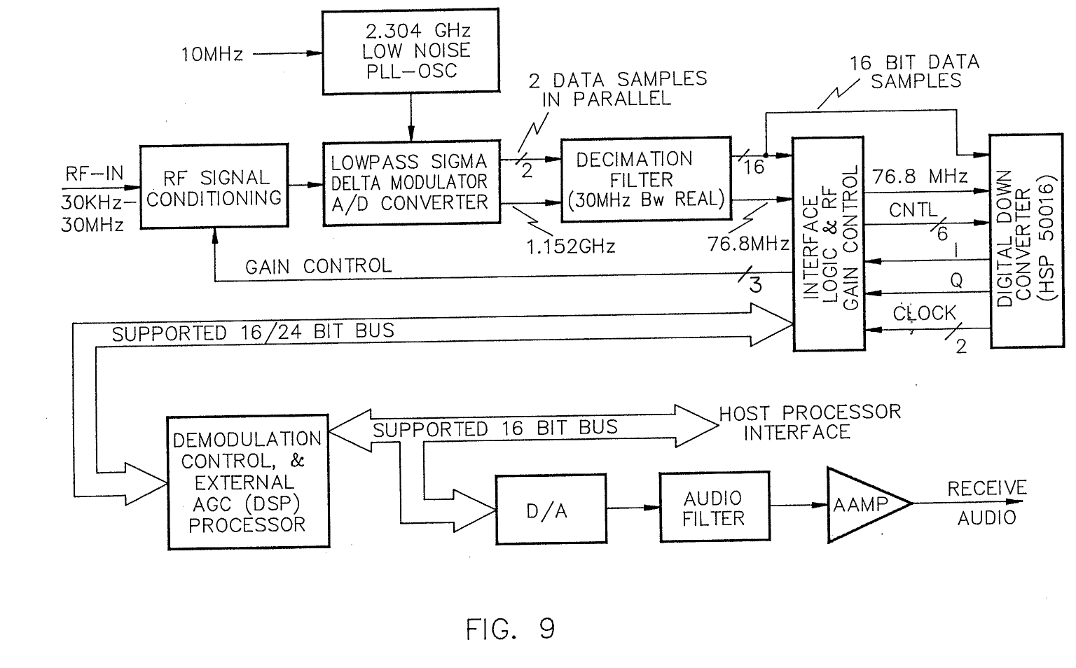

There is an alternate in-line multi stage sigma-delta modulator architecture that can be used for the multi band direct sampling receiver to provide high performance operation up to UHF and beyond. Referring now to FIG. 6, a bandpass sigma-delta modulator analog-to-digital converter is shown. The modulator comprises a configuration of tuned resonators in cascade and a 1-bit per sample A/D converter output as shown. The modulator is stabilized through integrator gain and time constant control and the feed forward and feed backward signal level adjustments. The resonator central response frequency is controlled by the individual resonator feedback gain adjustment. Further, the resonators tend to operate independent of each other and can be tuned to deepen and or widen the noise suppression notch. Unlike the low pass modulators, the band pass modulator's over-sampling ratio is not dependent upon carrier frequency, only on signal bandwidth. The disadvantage of this approach is that the modulator is more complex and must be step wise tuned across the band. The pass band must be wide enough to allow for signal frequency offset, signal bandwidth, and resonator tuning accuracy.

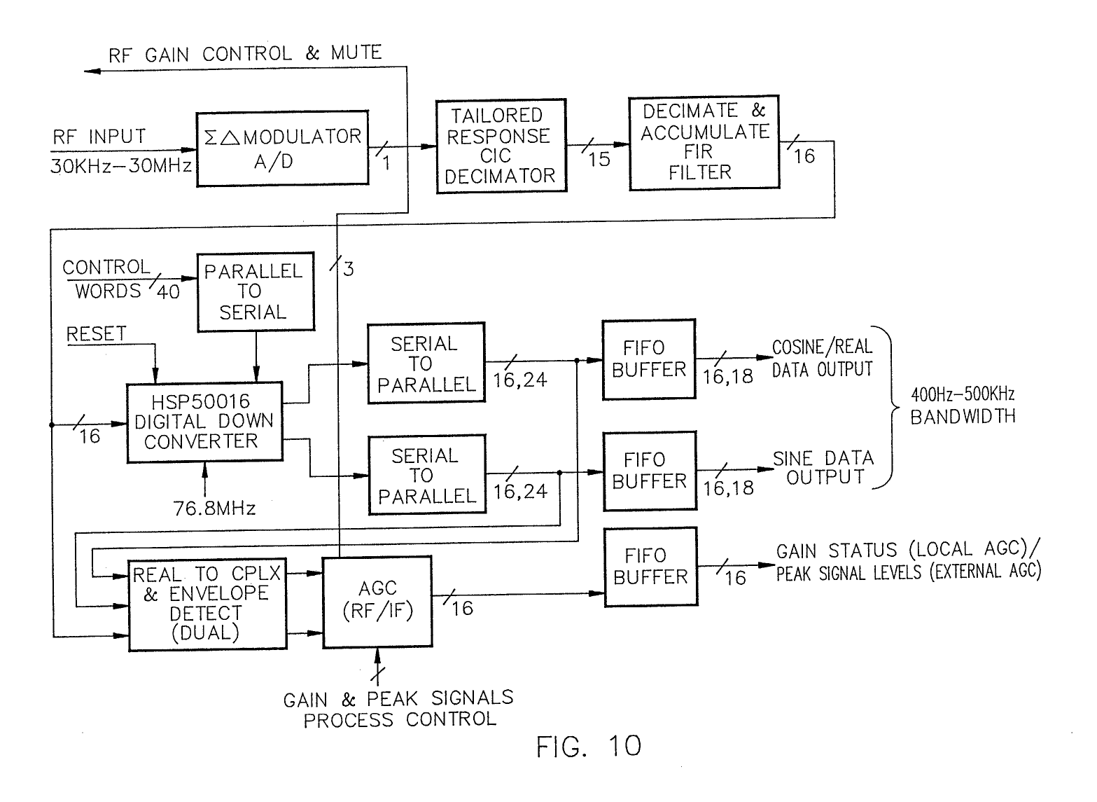

Referring now to FIG. 7, a graphical representation of the response of the bandpass sigma-delta modulator analog-to-digital converter of FIG. 6 is shown. As shown by the noise spectrum, the tuned passband can be made wider by offsetting separate resonator tune frequencies.

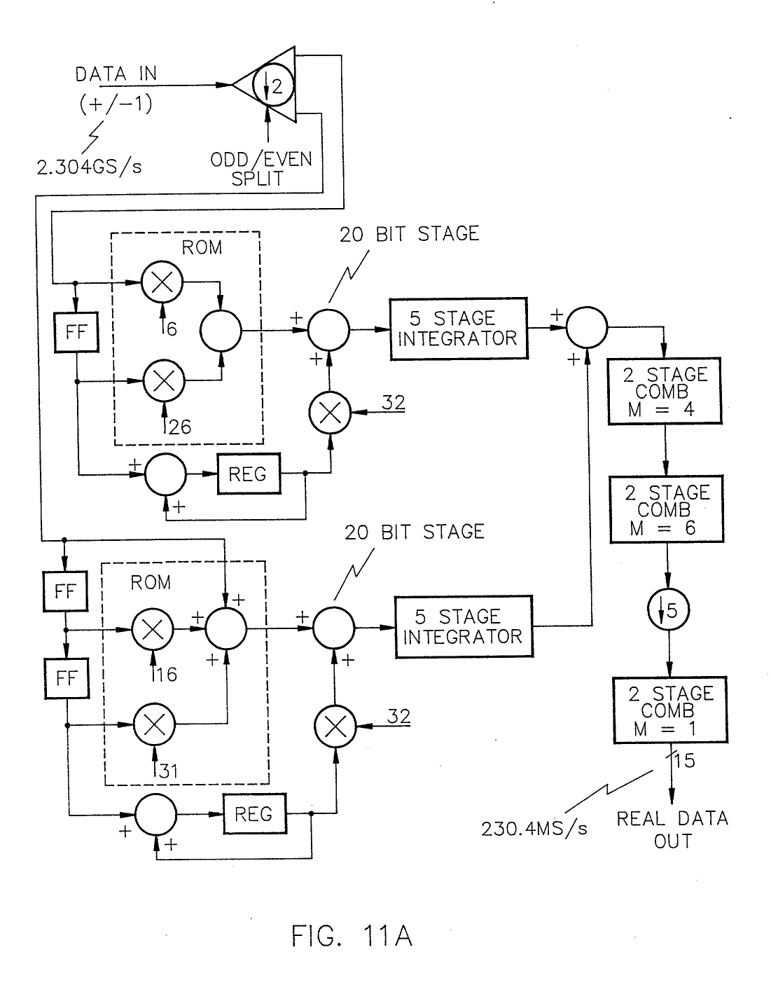

Referring now to FIG. 8, a block diagram of RF signal conditioning circuitry preceding analog-to-digital conversion is shown. The linearity and dynamic range of the A/D converter must not be compromised by the RF signal conditioning. Both the preselection filters, or anti-alias filters, and the AGC attenuator are implemented passively using integrated micro-relay switches, not p-i-n diode switches, to maintain the required high level of linearity. For HF only receivers, the preselection filter is a fixed 30 MHz BW low-pass filter. Both the RF IN port and the RF OUT port are 50 ohms.

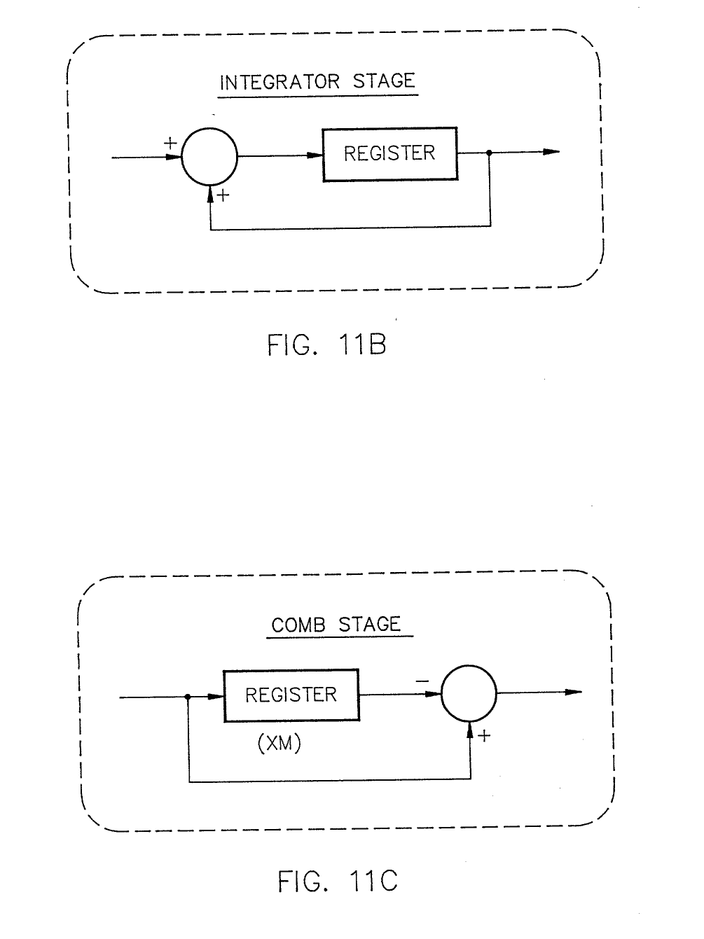

Referring now to FIG. 9, a block diagram of a preferred embodiment of a minimum level performance high-frequency (HF) band direct sampling receiver is shown. The 2.304 GHz sample clock is produced by a phase-locked loop stabilized crystal oscillator, locked to an external 10 MHz reference signal. The A/D converter is a low-pass sigma-delta modulator with a one bit per sample output at 2.304 GS/s. The A/D converter integrated circuit accepts a 50 ohm RF input and a differential CML 2.304 GHz clock input and produces the following differential CML outputs:

1 bit sample data out at 2.304 GS/s

2 bit parallel sample data out at 1.152 GS/s

2.304 GHz sample clock

1.152 GHz sample clock

In addition, the A/D converter IC contains the ACG attenuator and drive decoder with its 50 ohm input and output.

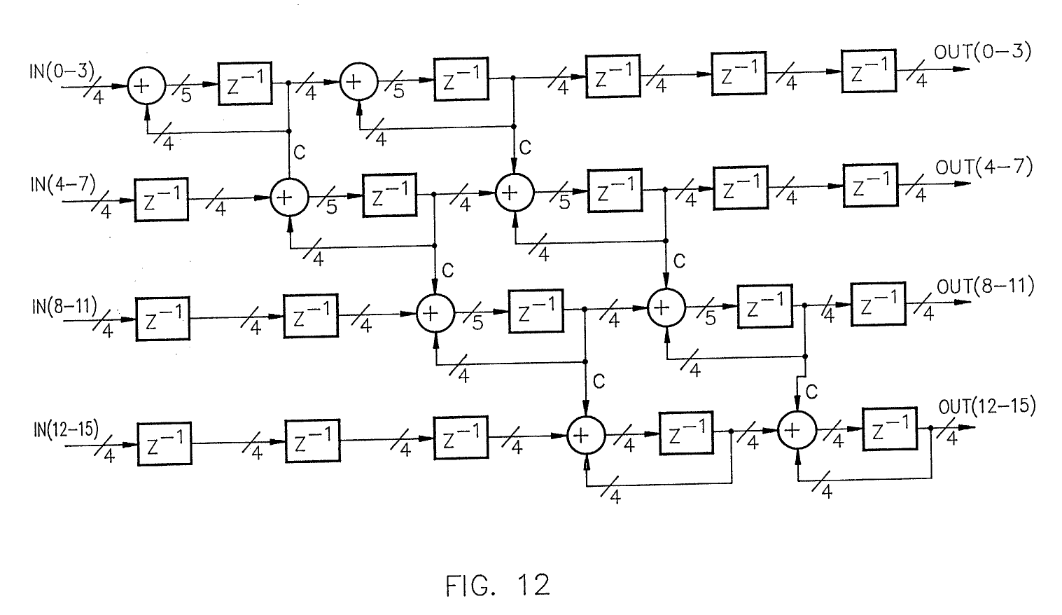

Referring now to FIG. 10, additional components of the high-frequency band direct sampling receiver including a decimation filter integrated circuit, digital down converter integrated circuit, and interface logic and RF gain integrated circuits are shown. The digital down converter chip may be a HSP50016 device available from Harris Corporation which utilizes high speed CMOS from Hewlett-Packard Corporation. The local ACG would allow for limited programmability by strap selection as well as processed peak signal levels for external ACG algorithms, programmed into the demodulation digital signal processor.

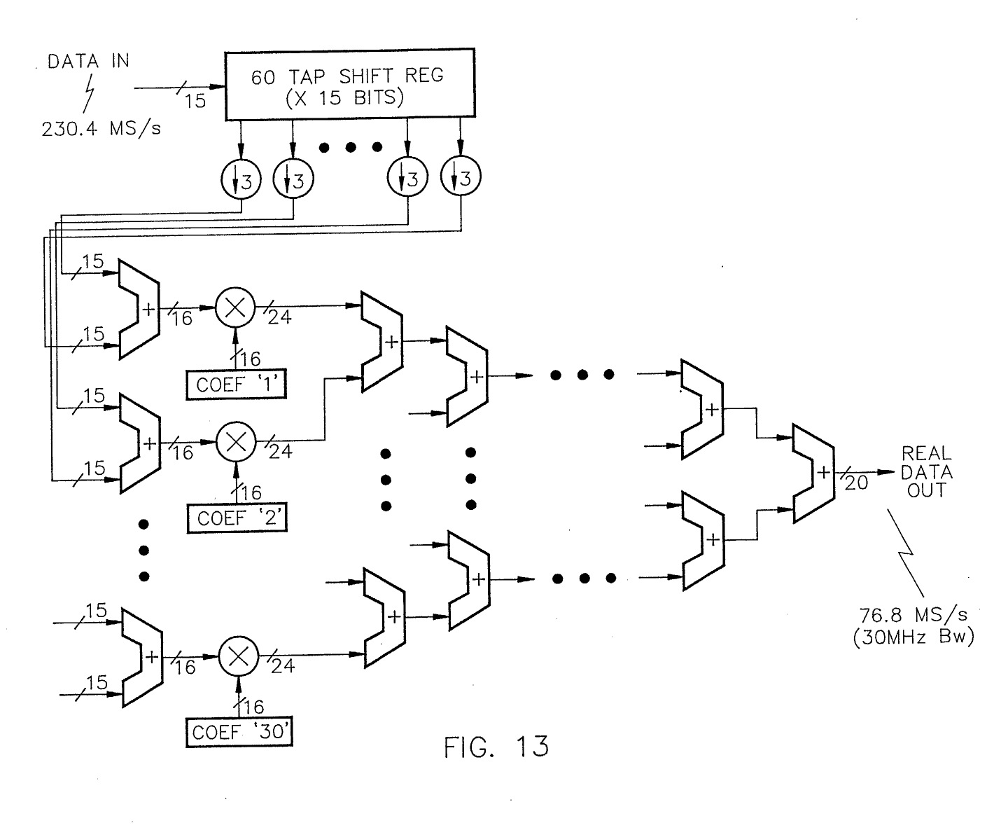

Referring now to FIGS. 11A, 11B and 11C, a synthesized response CIC decimation filter, a six stage filter which is specially configured to synthesize the required cascaded integrator response from two input samples at a time is shown. This allows the integrations to be done at 1.152 GS/s rather than the normal 2.304 GS/s rate. The decimation filter is composed of a tailored response CIC decimator followed by a decimate and accumulate FIR filter. The overall rate reduction of the CIC decimator is ten, two prior to integration and five prior to the output rate two stage comb filter. The other four comb stages are implemented at 1.152 GS/s such that the comb delay can be adjusted to place two comb notches on either side of the output rate. By controlling the number of sample delay registers ‘M’ in each comb filter stage, the frequency response zeros can be spread so as to provide wider pass bandwidths with anti alias noise protection.

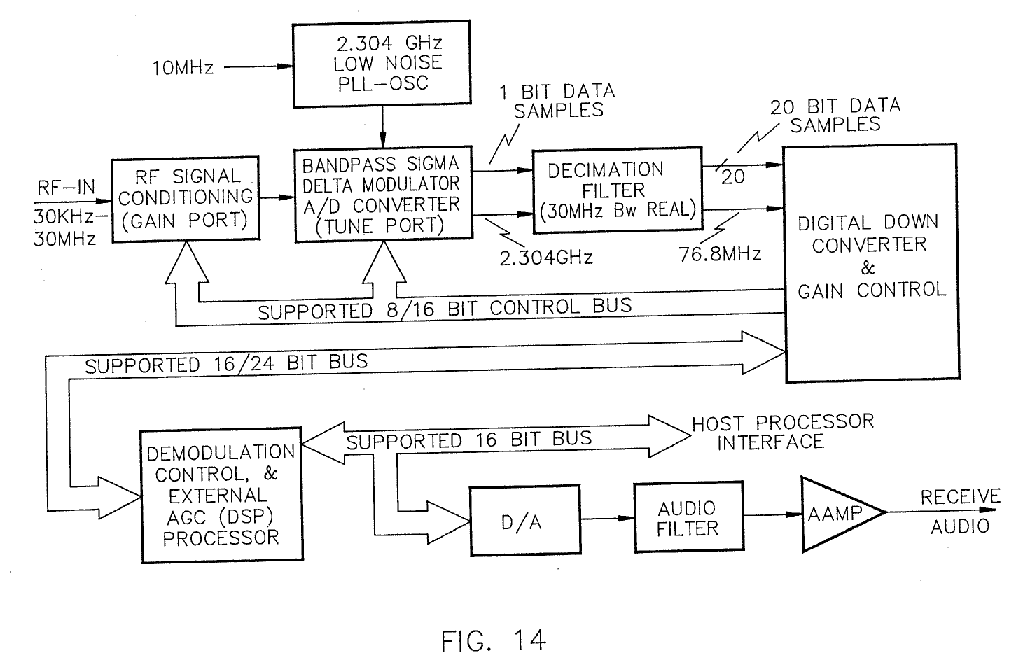

Referring now to FIG. 12, a z-domain staggered pipeline integration technique of a dual integrator cascade which is representative for constructing high resolution adders, subtractors, and integrators at high processing speeds is shown.

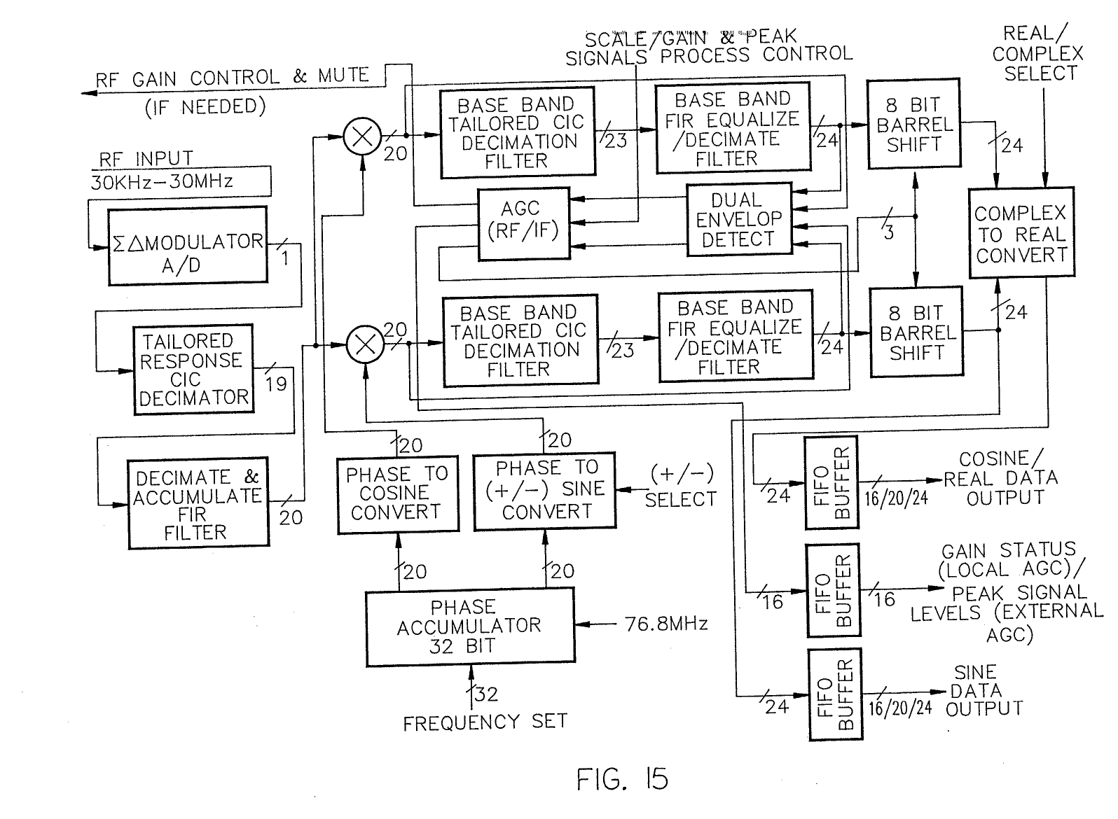

Referring now to FIG. 13, a decimate and accumulate FIR filter, a 60-tap symmetric coefficient set filter, is shown. The 230.4 MS/s filter input is further decimated by three by the filter to 76.8 Ms/s output rate. Because the filter is implemented as decimate then accumulate, there are 3 input register shifts before each output sample is accumulated. In this way, output samples are not calculated if they are not to be used.

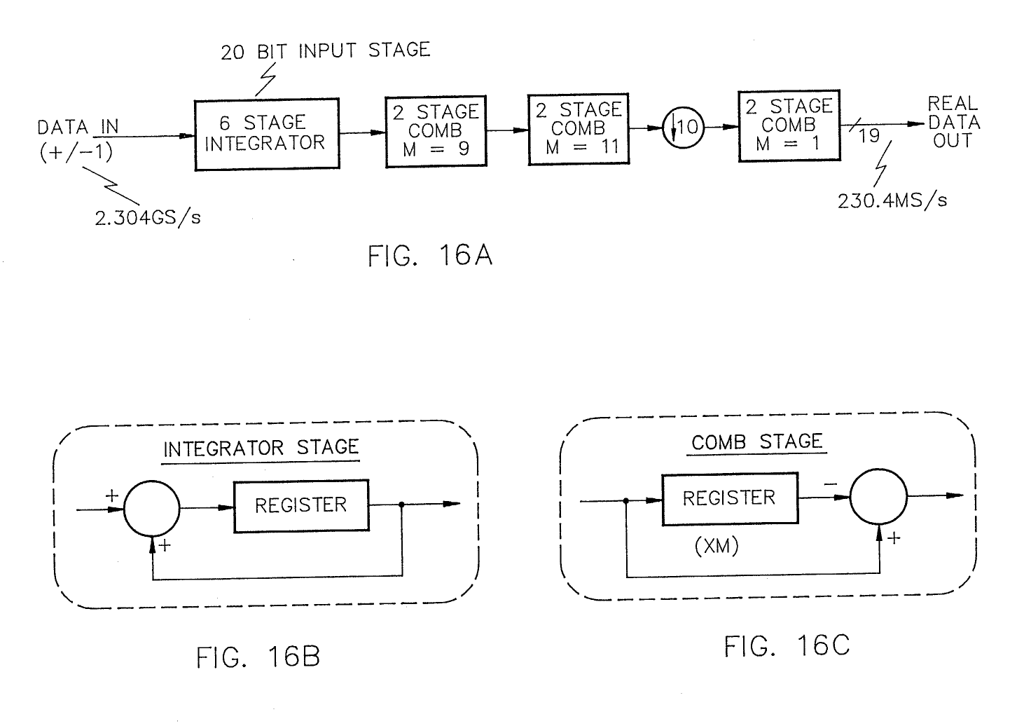

Referring now to FIG. 14, a block diagram of a high performance high-frequency band direct sampling receiver of the present invention is shown. Since the high performance HF band receiver requires up to 24-bit resolution, the HSP50016 digital down converter cannot be used as it cannot provide much more than 18 effective bits of resolution (do to internal resolution limitations).

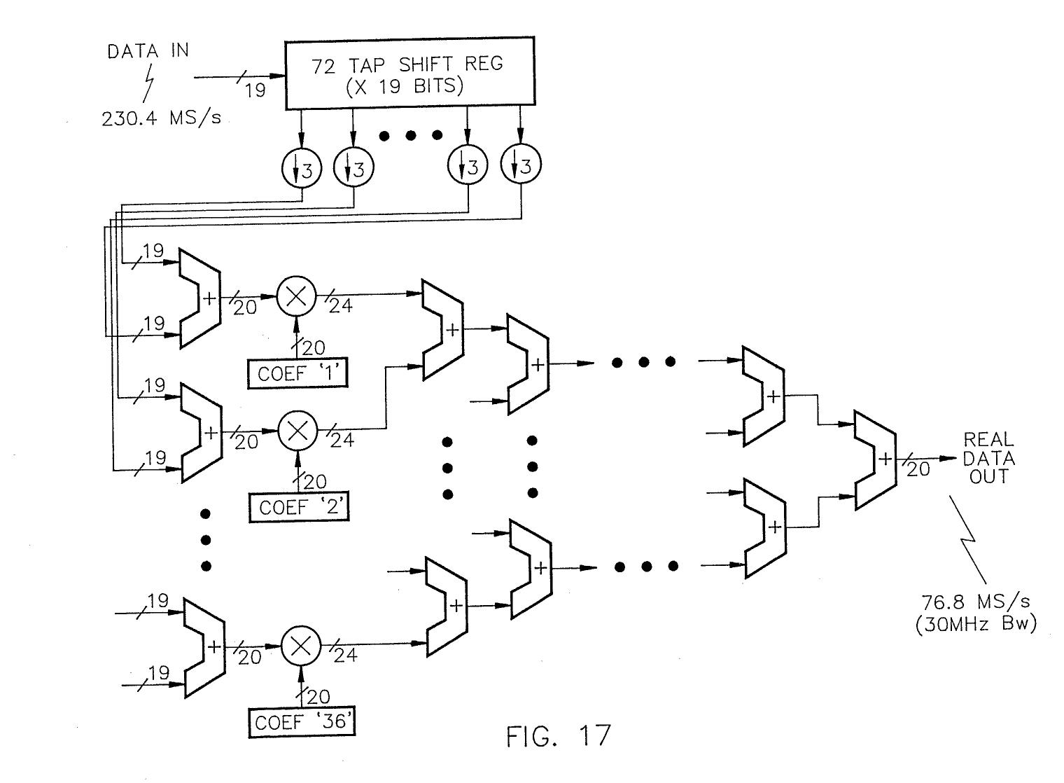

Referring now to FIG. 15, a block diagram of a high-frequency band direct sampling receiver of the present invention providing an analog-to-digital converter with a decimation filter, a digital down converter, and a gain control circuit, all having enhanced performance is shown. The real 20-bit decimation filter integrated circuit output is translated to complex base band by the quadrature multiplication with a fine resolution carrier, normally at the desired signal's frequency. The quadrature carrier is produced by the 32-bit phase accumulator, whose 20 MSBs of phase output are converted to sine and cosine carriers by CORDIC processors. Both the phase accumulator and the CORDIC processors are pipelined structures composed of adders, subtractors, and registers. The local AGC would allow for limited programmability by strap selection as well as processed peak signal levels for external AGC algorithms, programmed into the demodulation DSP. In this high performance digital down converter, the full resolution 24-bit outputs can be scaled by the barrel shifters and passed to the demodulator DSP as 24-bit, 20-bit or 16-bit resolution. The RF gain control and mute is now only needed for overload control of the A/D input under high level interference situations such as simultaneous transmission. There is also a one-quarter sample rate translation option for a real data output when desired.

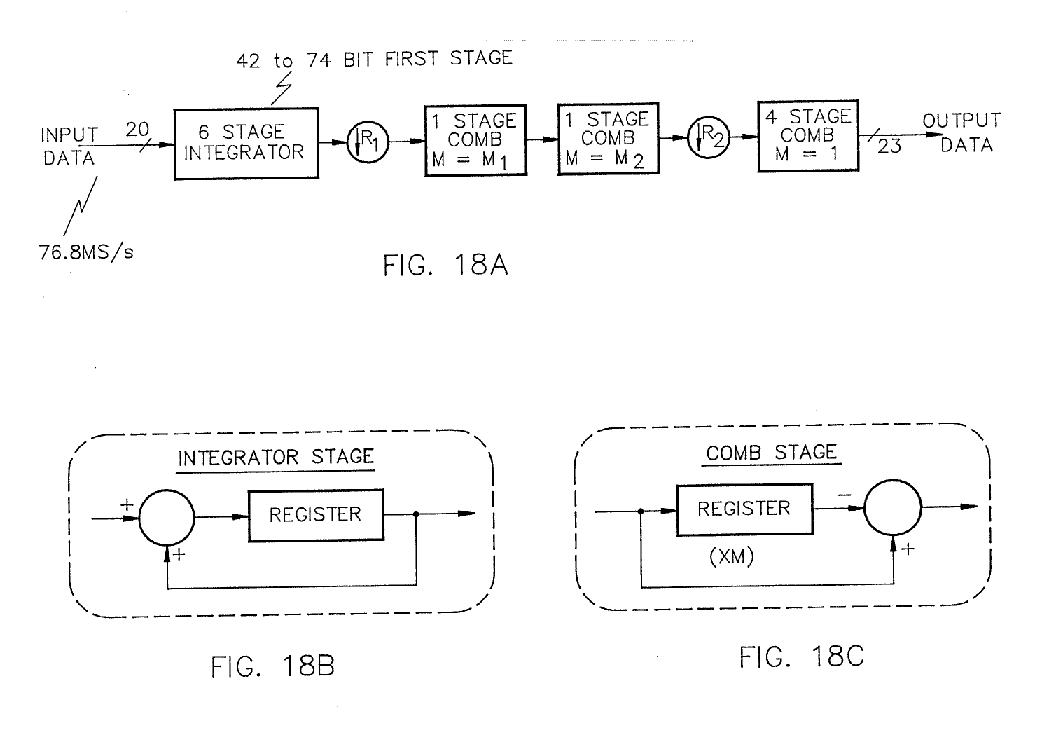

Referring now to FIGS. 16A, 16B and 16C, a tailored response CIC decimation filter, a six stage filter with the cascaded integrators required to process the 1-bit sample inputs at 2.304 GS/s in order to achieve the enhanced performance is shown. The decimation filter is composed of a tailored response CIC decimator followed by a decimate and accumulate FIR filter. The rate reduction is ten, prior to the output rate two stage comb filter. The other four comb stages are implemented at 2.304 GS/s such that the comb delay can be adjusted to place two comb notches on either side of the output rate.

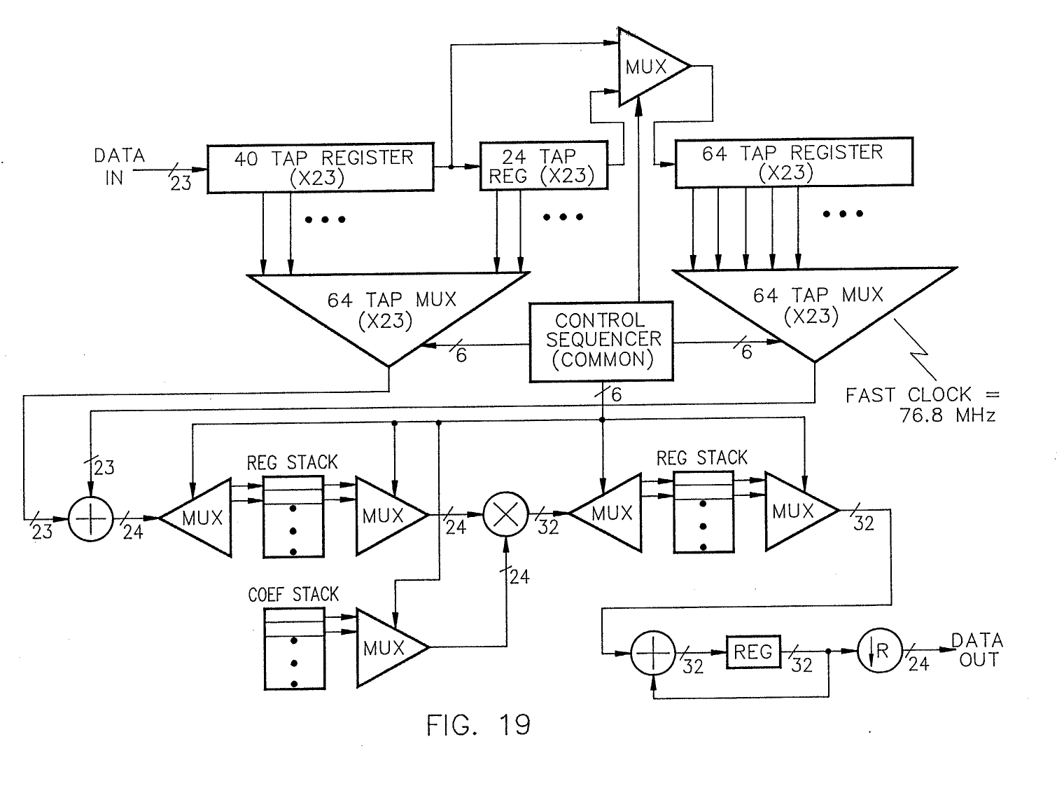

Referring now to FIG. 17, a diagram of decimate and accumulate FIR filter, a 72-tap symmetric coefficient set filter, is shown. The 230.4 MS/s filter output is further decimated by three in the filter.

As shown in FIG. 15, once the complex data signal is translated to base band, each channel (I & Q) provides programmable decimation filtering. Each decimation filter consists of a baseband tailored response CIC decimation filter followed by a baseband FIR equalize and decimate filter.

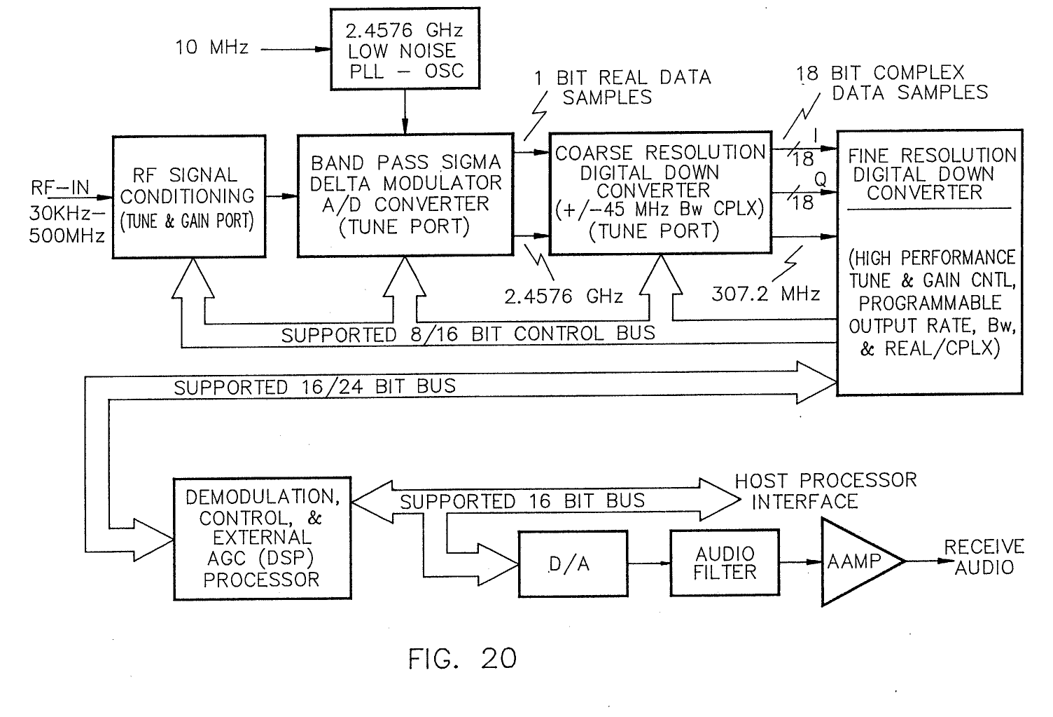

Referring now to FIGS. 18A, 18B and 18C, a baseband CIC decimation filter, a six stage filter with several selectable (by R₁, R₂ combination) decimation rates, with output rates from 1.92 MS/s down to 150 KS/s, with staggered comb filter stages, is shown. The filter has two of its six comb stages operating at the 76.8 MS/s input rate divided by R₁, such that the comb delay can be adjusted to place a comb notch on either side of the output rate and enhance its bandwidth performance.

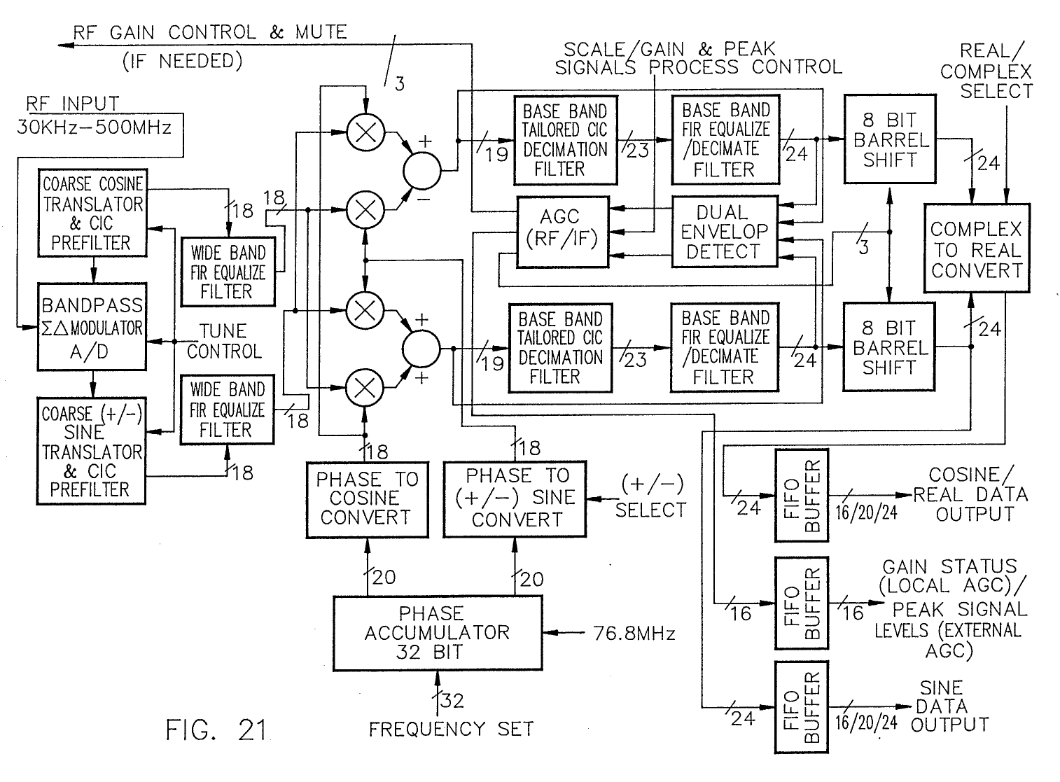

Referring now to FIG. 19, programmable 128-tap symmetric coefficient baseband FIR equalize and decimate filter is shown. The 23-bit CIC decimation filter outputs are further filtered and amplitude equalized by the FIR filter. The filter is structured to multiplex the tap data through the same multiply and accumulate processing elements in a pipeline fashion at the 76.8 MHz, fast clock rate. As such, the 1.92 MS/s maximum input rate is limited to 80 taps. There is a programmable 1 through 16 output rate reduction (R) available for the 24-bit data output.

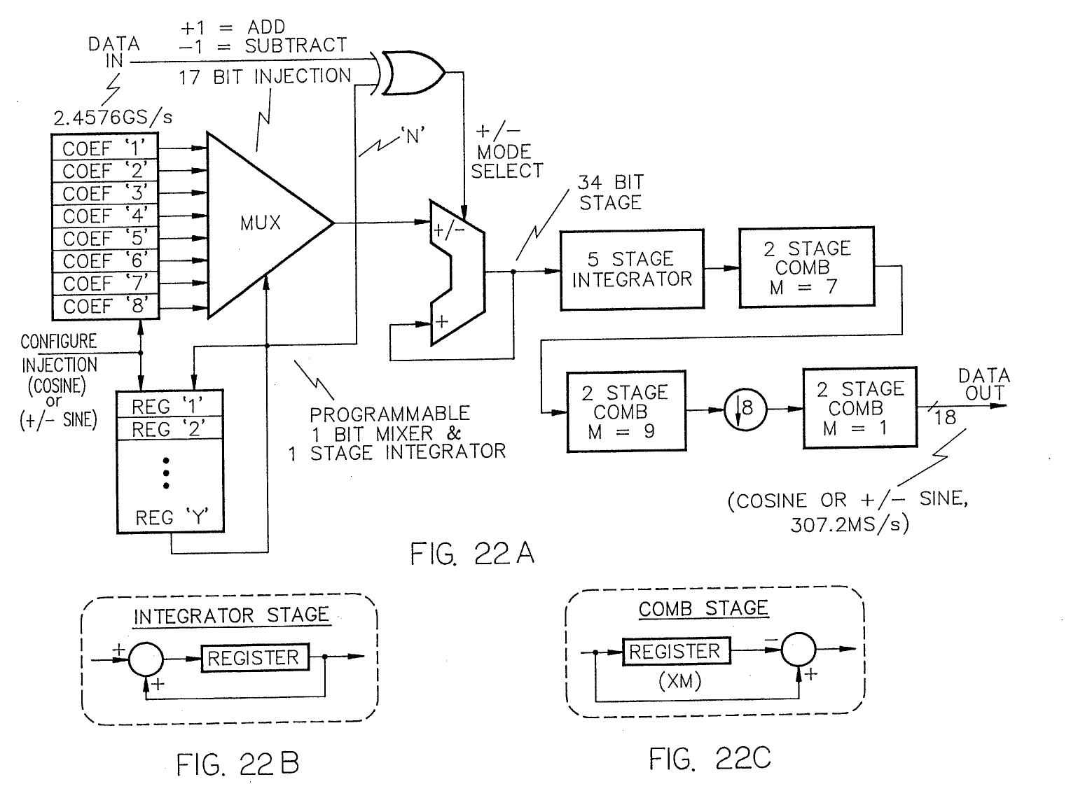

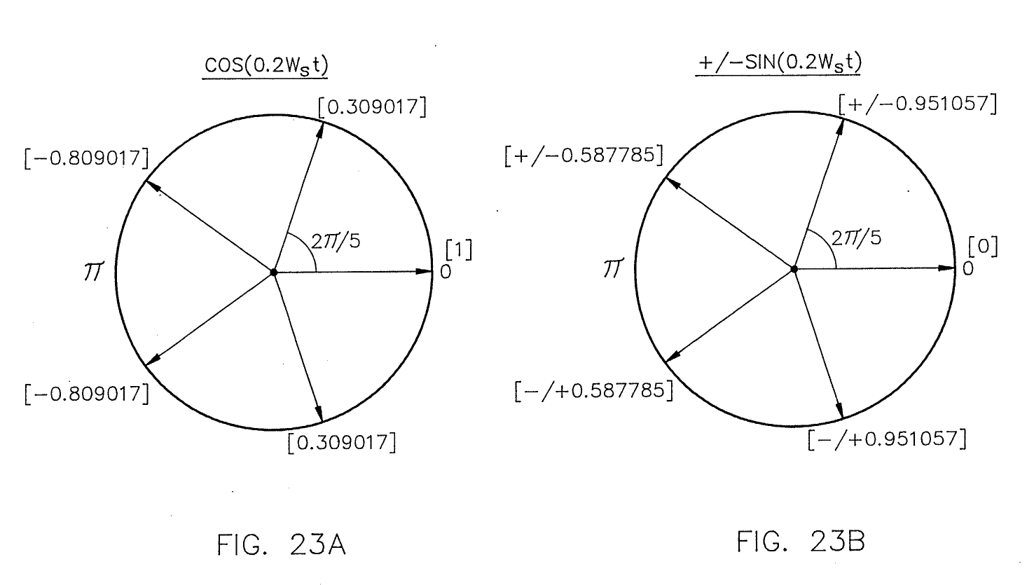

Referring now to FIGS. 20 and 21, a high performance multi-band direct sampling receiver in accordance with the present invention is shown. The multi-band direct sampling receiver is similar in architecture thereto to the high performance HF only direct sampling receiver, the main difference being:

1) The inclusion of a Band selectable preselector in the RF signal conditioning

2) 2.4576 GHz A/D sample clock rather than 2.304 GHz

3) The high speed decimation filter is changed to a coarse resolution digital down converter with a 90 MHz complex data bandwidth

4) The fine resolution digital down converter operates on the complex +/−45 MHz bandwidth input data rather than the real 30 MHz bandwidth input data. As such, a full complex multiplication is performed on the 307.2 MS/s complex input data using a fine resolution quadrature injection. The quadrature injection allows for both positive and negative programmable frequencies for access to the full +/−45 MHz input bandwidth.

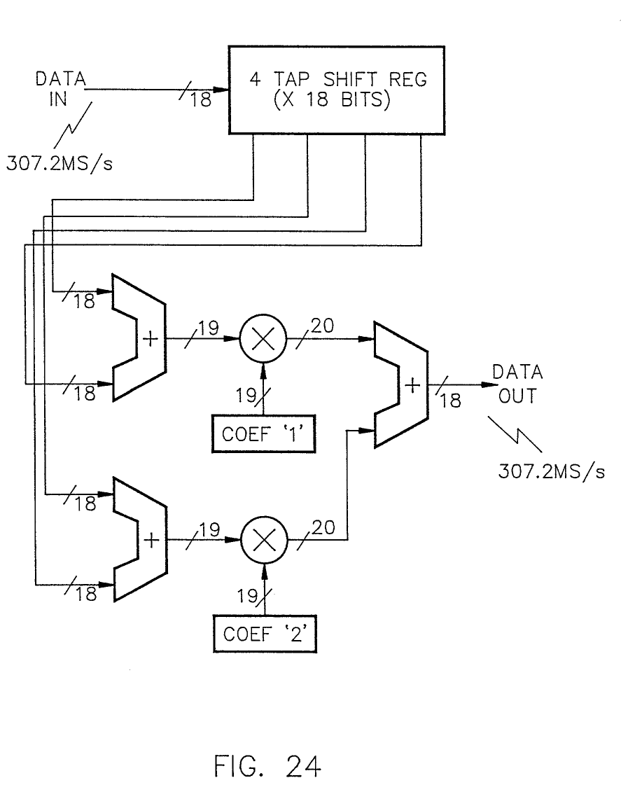

Referring now to FIGS. 22A, 22B and 22C, a coarse resolution digital down converter comprising two (I & Q channels) coarse translators and CIC pre-filters is shown.

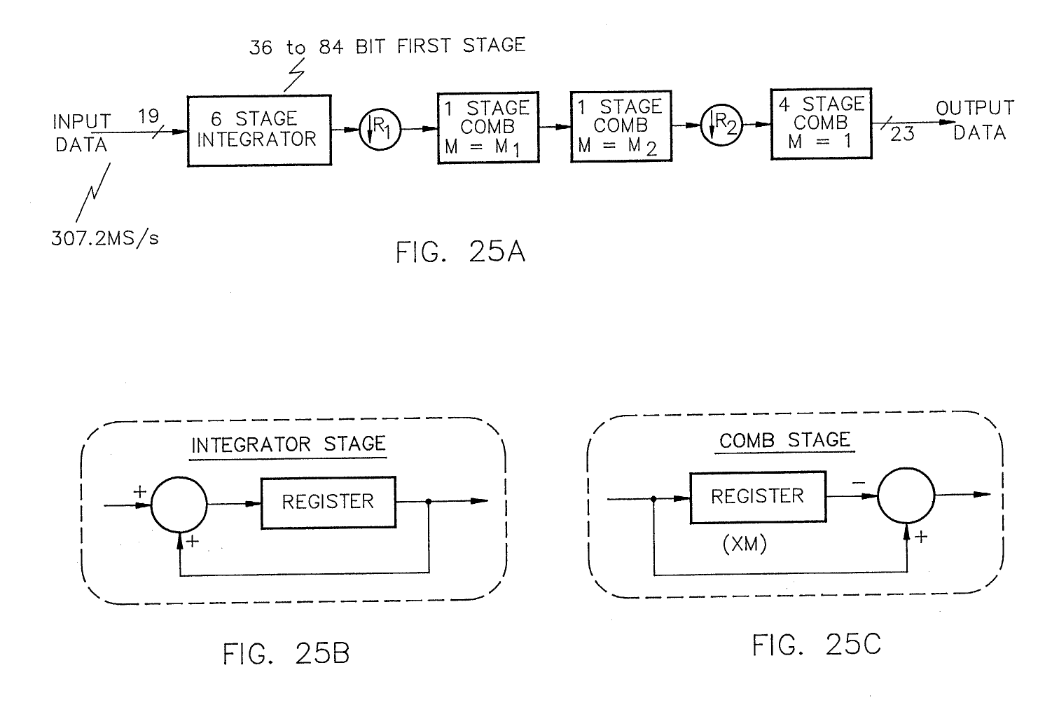

Referring now to FIGS. 23A and 23B, the sine and cosine injection values for ‘Y’=5 or ⅕ the sample rate illustrating a coarse translation injection example is shown. The injection frequency's are integer divisions of the input sample rate. This complex injection at 491.5 MHz translates the 446.5 MHz to 536.5 MHz band to complex base band and +/−45 MHz. The complex injection coefficients are programmed into the muliplexer selected RAM stacks. The multiplexer selection addresses as well as coeffeicient polarity bits are programmed into configurable register stacks, whose length is set to the injection frequencies division ratio (5 in this example). Since the input data is 1 bit differential as shown in FIG. 22, the individual input data bits simply add or subtract the appropriate injection coefficients from the repeating sequence into the first integrator stage. The CIC pre-filter is a six stage filter providing a rate reduction of eight, prior to the output rate two stage comb filter. The other four comb stages are implemented at 2.4576 GS/s such that the comb delay can be adjusted to place two comb notches on either side of the output rate. The filter is fully linear except for the frequencies between the periodic comb notches, which is of no consequence since the amplitude response is minimized.

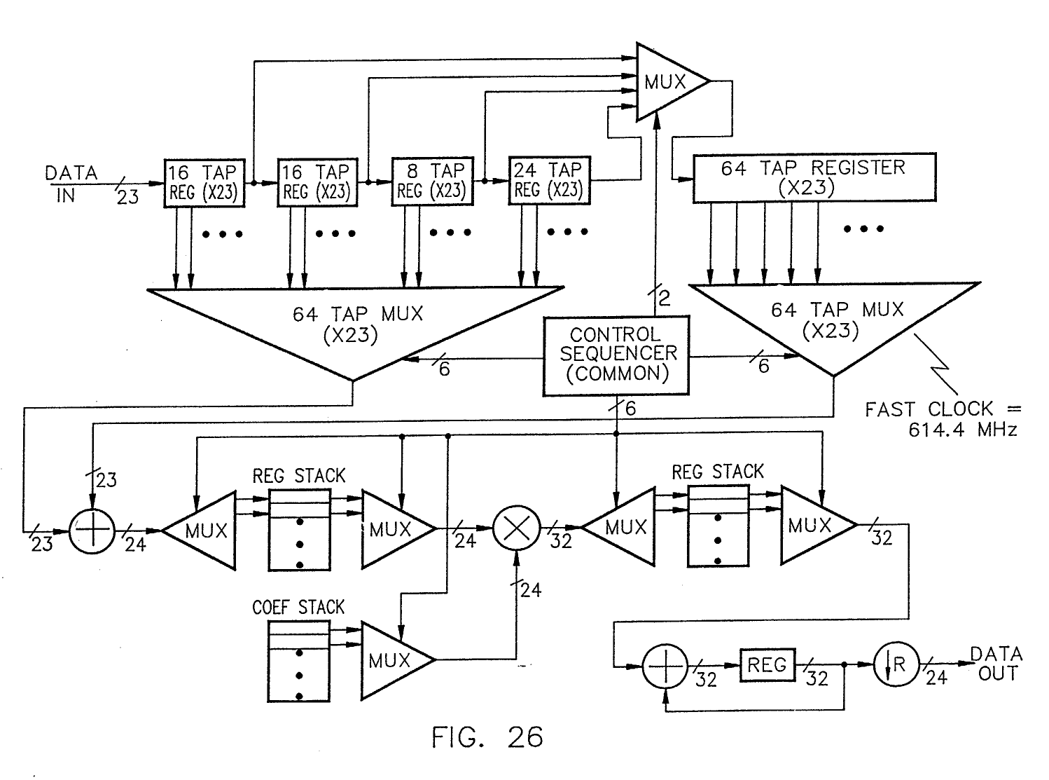

Referring now to FIG. 24, a four-tap FIR pre-filter equalizer is shown. The 307.2 MS/s CIC filter output is amplitude equalized by the FIR filter.

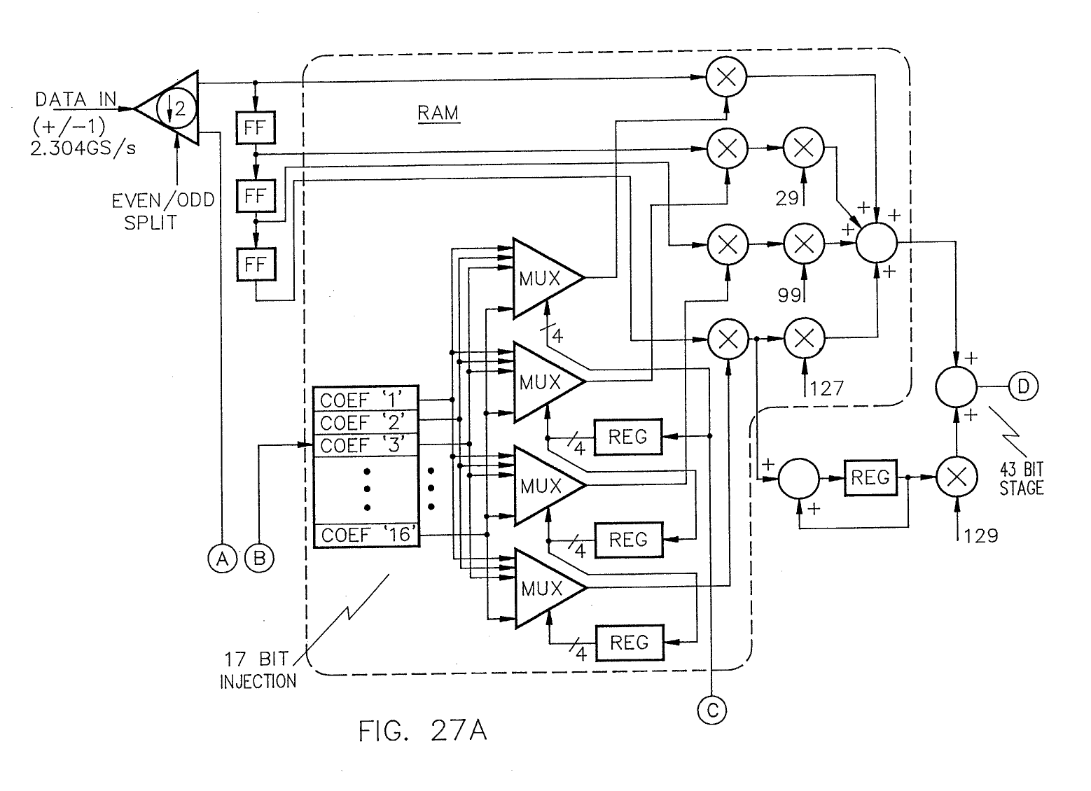

Referring now to FIGS. 25A, 25B and 25C, a baseband CIC decimation filter with staggered comb filter stages, a six stage filter with several selectable (by R₁, R₂) decimation rates and output rates from 38.4 MS/s down to 150 KS/s. A shown in FIG. 21, once the coarsely translated complex data signal is finely translated to base band, each channel (I & Q) provides programmable decimation filtering. Each decimation filter consists of a baseband tailored response CIC decimation filter followed by a baseband FIR equalize and decimate filter. The CIC filter has two of its six comb stages operating at the 307.2 MS/s input rate divided by R₁ such that the comb delay can be adjusted to place a comb notch on either side of the output rate and enhance its bandwidth performance.

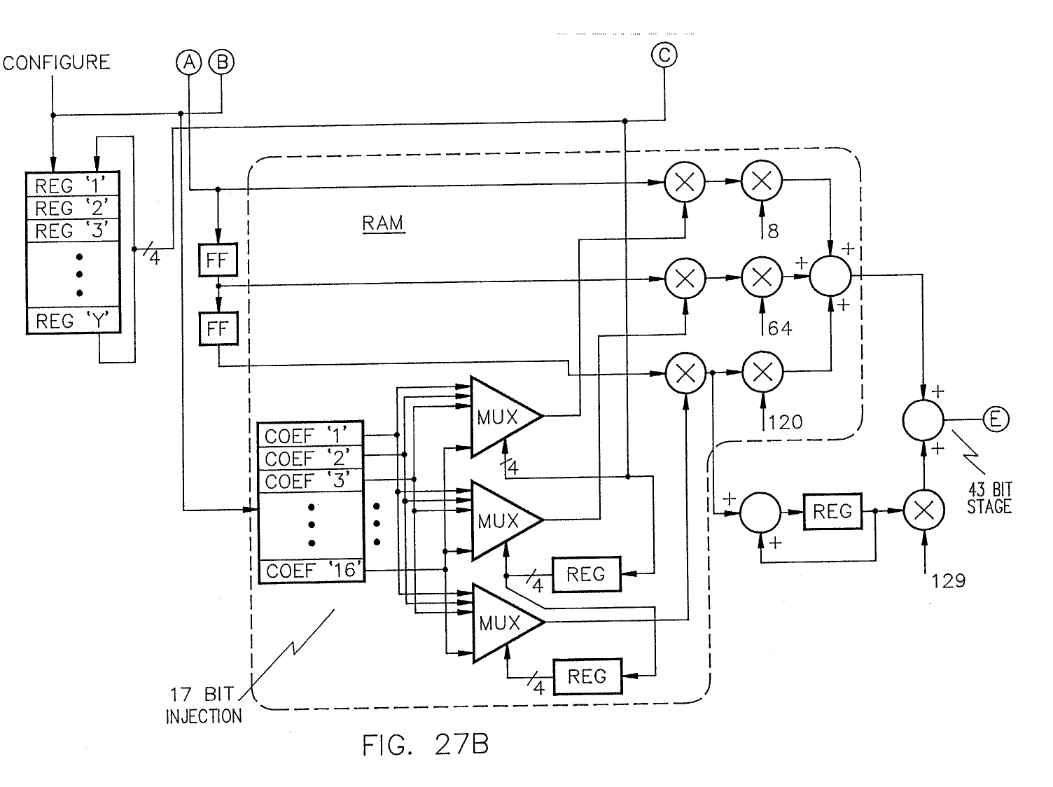

Referring now to FIG. 26, a programmable 128-tap symmetric coefficients baseband FIR equalize and decimate filter is shown. The 23-bit CIC decimation filter outputs are further filtered and amplitude equalized by the FIR filter. There is a programmable one through 16 output rate reduction available for the 24-bit output data. The filter is structured to multiplex the tap data through the same multiply and accumulate processing elements in a pipeline fashion at a 614.4 MHz fast clock rate. As such, the 38.4 MS/s, 19.2 MS/s and 15.36 MS/s input rates are limited to 32, 64 and 80 taps respectively.

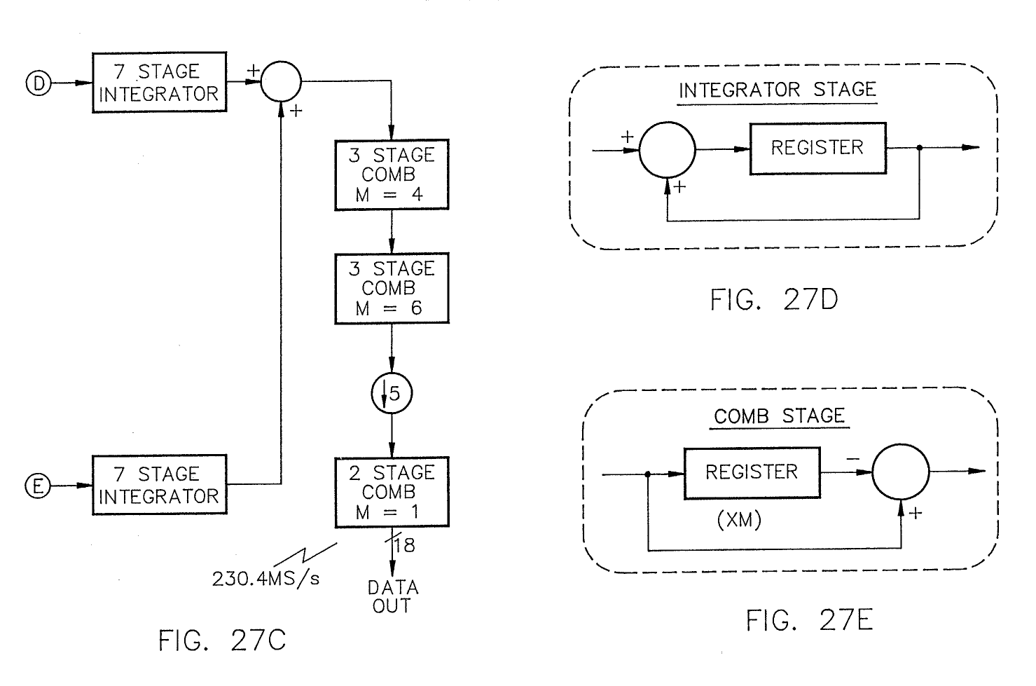

Referring now to FIGS. 27A, 27B, 27C, 27D and 27E, a block diagram of an alternate high performance coarse complex translator and synthesized response CIC pre-filter that operates at 1.152 GS/s on two 1-bit samples in parallel is shown. As was the case for the HF minimum performance high speed decimation filter, the multi-band high performance coarse digital down converter can be configured to process input data samples two at a time at half the processing speed. Two small memories, each with two outputs, are used to implement the coarse injection multiplications with the input data. One RAM has an 8-bit address reflecting current coefficient selection and past 4 even bits of the input data pair. The other RAM has a 7-bit address reflecting current coefficient selection and past three odd bits of the input data bit pair. Note that since input bits are delayed, the corresponding injection multiplexer addresses must also be delayed. The constant multiplications performed before and after the first integrators are determined such that the output from the sum of the two integrator cascades is equivalent to the output from a single 8 stage integrator cascade running at 2.304 GS/s and then decimated by 2 to 1.152 GS/s. Note also that the master sample clock is 2.304 GHz as was the case for HF direct sampling receivers. Similarly, parallel processing networks can be configured for the first integrator stages such that more than 2 bits can be processed in parallel, thereby further reducing the clock rate of individual integrators. The CIC pre-filter is an eight stage filter rather than a six stage filter. The overall rate reduction is ten, two prior to integration and five prior to the output rate stage two comb filter. The other six comb stages are implemented at 1.152 GS/s such that the comb delay can be adjusted to place three comb notches on either side of the output rate.

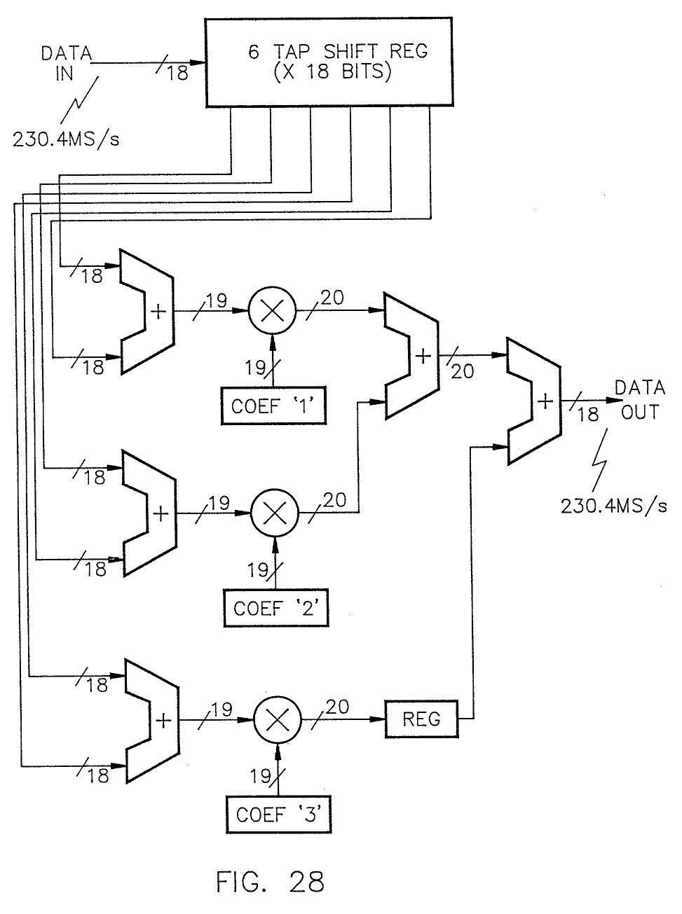

Referring now to FIG. 28, a 6-tap FIR pre-filter and equalizer is shown. The 230.4 MS/s alternate filter output is amplitude equalized by the FIR filter.

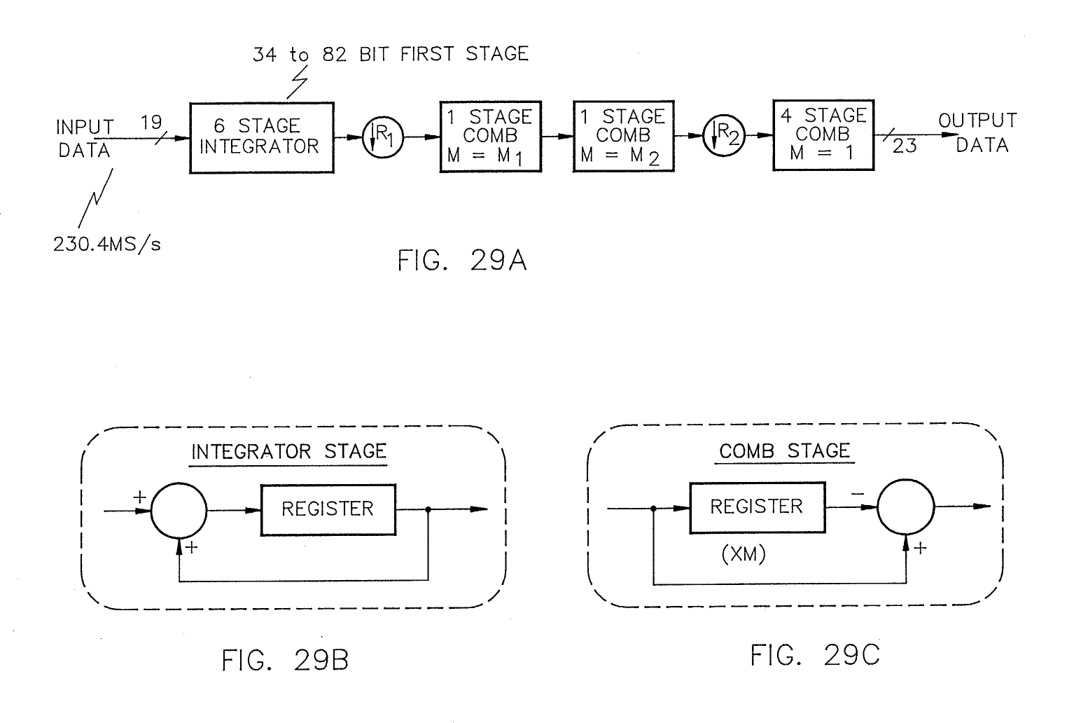

Referring now to FIGS. 29A, 29B and 29C, a baseband CIC decimation filter with staggered comb filter stages is shown to work with the alternate coarse complex translator of FIG. 27. Since the coarse digital down converter output is at 230.4 MS/s rather than 307.2 MS/s, the fine digital down converter's quadrature injection is at 230.4 MS/s also. The filter supports the same output data rates as the 307.2 MS/s input rate filter.

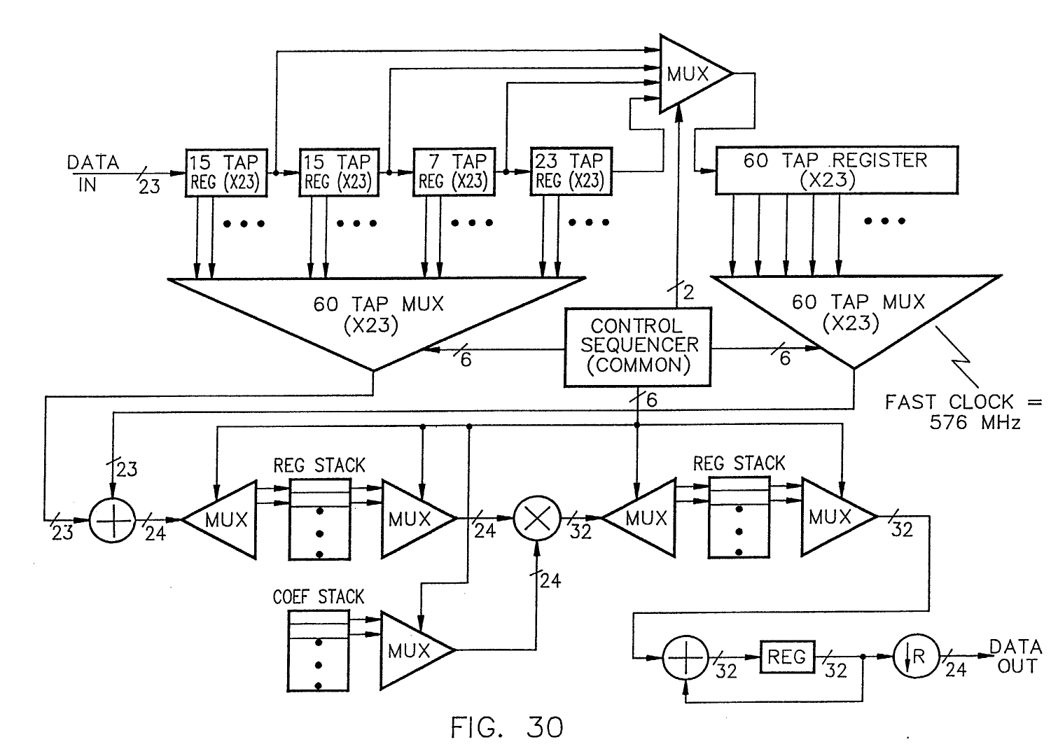

Referring now to FIG. 30, a baseband FIR equalize and decimate filter is shown to work with the CIC decimation filter of FIG. 29. The filter uses a lower fast process clock, 576 MHz rather than 614.4 MHz. As such, the maximum filter length is 120 taps rather than 128 taps.

For most single channel audio and low rate data applications, a single programmable digital signal processor, with D/A voice reconstruction and message data interface support, will complete the direct sampling receiver. The ADSP-2101 16-bit integer DSP or the more powerful TMS32uC30 32-bit floating point DSP will handle most of these applications, especially HF only applications. For wide bandwidth data, multi-channel reception, ECCM, Encryption and ESM applications, a more powerful processor or processor array may be required. The integrated communications processor under development by CACD utilizes ADSP-2101 DSP and accepts 96 KS/s real data for modulated voice receptions and 200 KS/s real data for wider bandwidth modulated signals. As such, integer division compatibility between the A/D sample clock and these output sample rates is required. The D/A converter should have a minimum of 12-bit resolution and allow for generous ever sampling to reduce the requirements on the audio filter for quality audio. The direct sampling receiver is configured to support a high degree of real time AGC control via programmed algorithms in the digital down converter and the DSP. In external AGC mode, peak signal levels are determined from both the fine resolution digital down converter input data samples and the sine and cosine data output, based on current gain settings, and provided to the DSP on a selectable update rate basis. Additional preprocessing of the peak levels may be selectably performed before being passed to the DSP, such as averages of the n highest peak levels (TBD). Since the direct sampling receiver is inherently wide band prior to A/D conversion, with no frequency synthesizers to tune, and all digital frequency selective tuning performed by very fast numerically processed oscillators, rechannelization of the direct sampling receiver should be of low to sub-microsecond tune time. This makes the direct sampling receiver particularly attractive in ESM and ECCM applications, and the DSP's processing capabilities need to be sufficient to not limit the performance of the direct sampling receiver.

It is believed that multi-band direct sampling receiver of the present invention and many of its attendant advantages will be understood by the foregoing description, and it will be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

What is claimed is:

1. A multi-band direct sampling radio receiver, comprising:
a preselector receiving a radio-frequency input signal for selecting the frequency band of the received radio frequency signal;
a low-pass or band-pass sigma-delta modulator analog-to-digital converter receiving the preselected radio-frequency input signal from said preselector, said low-pass or band-pass sigma-delta modulator analog-to-digital converter converting the radio-frequency input signal into a discrete-time digital signal;
a digital down converter receiving the discrete-time digital signal from said low-pass or band-pass sigma-delta modulator analog-to-digital converter for reducing the frequency of the discrete-time digital signal;
a digital signal processor receiving the discrete-time digital signal from said digital down converter for digitally processing and demodulating the discrete-time digital signal and passing said demodulated discrete-time digital signal to an external host interface; and
a digital-to-analog converter receiving the discrete-time digital signal from said digital signal processor for converting the discrete-time digital signal into a continuous-time analog output signal.

2. A multi-band direct sampling radio receiver as claimed in claim 1, wherein said digital down converter provides a tune control signal to said preselector and to said bandpass sigma-delta modulator analog-to-digital converter.

3. A multi-band direct sampling radio receiver as claimed in claim 2, wherein said tune control signal is programmable.

4. A multi-band direct sampling radio receiver as claimed in claim 1, further comprising a filter receiving the continuous-time analog output signal for frequency conditioning the continuous-time output signal.

5. A multi-band direct sampling radio receiver as claimed in claim 1, further comprising an amplifier for increasing the level of the continuous-time analog output signal.

6. A multi-band direct sampling radio receiver as claimed in claim 1, wherein said digital down converter provides a gain control signal to said preselector.

7. A multi-band direct sampling radio receiver as claimed in claim 6, wherein said gain control signal is programmable.

8. A multi-band direct sampling radio receiver, comprising:
a preselector receiving a radio-frequency input signal for selecting the frequency band of the received radio frequency signal;
a low-pass or band-pass sigma-delta modulator analog-to-digital converter receiving the preselected radio-frequency input signal from said preselector, said low-pass or band-pass sigma-delta modulator analog-to-digital converter converting the radio-frequency input signal into a discrete-time digital signal;
a coarse resolution digital down converter receiving the discrete-time digital signal from said low-pass or band-pass sigma-delta modulator analog-to-digital converter for reducing the frequency of the discrete-time digital signal;
a fine resolution digital down converter receiving the discrete-time digital signal from said coarse resolution digital down converter for further reducing the frequency of the discrete-time digital signal;
a digital signal processor receiving the discrete-time digital signal from said fine resolution digital down converter for digitally processing and demodulating the discrete-time digital signal and passing said demodulated discrete-time digital signal to an external host interface; and
a digital-to-analog converter receiving the discrete-time digital signal from said digital signal processor for converting the discrete-time digital signal into a continuous-time analog output signal.

9. A multi-band direct sampling radio receiver as claimed in claim 8, wherein said fine resolution digital down converter provides a tune control signal to said preselector, to said bandpass sigma-delta modulator analog-to-digital converter and to said coarse resolution digital down converter.

10. A multi-band direct sampling radio receiver as claimed in claim 9, wherein said tune control signal is programmable.

11. A multi-band direct sampling radio receiver as claimed in claim 8, further comprising a filter receiving the continuous-time analog output signal for frequency conditioning the continuous-time output signal.

12. A multi-band direct sampling radio receiver as claimed in claim 8, further comprising an amplifier for increasing the level of the continuous-time analog output signal.

13. A multi-band direct sampling radio receiver as claimed in claim 8, wherein said digital down converter provides a gain control signal to said preselector.

14. A multi-band direct sampling radio receiver as claimed in claim 13, wherein said gain control signal is programmable.
